(19) United States
(12) Patent Application Publication
(10) Pub. No.: US 2004/0085887 A1
(43) Pub. Date: May 6, 2004

(54) Method and apparatus for recording data in optical recording medium and optical recording medium

(75) Inventors: Takashi Horai, Chuo-ku (JP); Hiroyuki Arioka, Chuo-ku (JP); Narutoshi Fukuzawa, Chuo-ku (JP); Syuji Tsukamoto, Chuo-ku (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Chuo-ku (JP)

(21) Appl. No.: 10/693,314

(22) Filed: Oct. 24, 2003

(30) Foreign Application Priority Data
Oct. 30, 2002 (JP) 2002-316216

(51) Int. Cl. G11B 7/00

(52) U.S. Cl. 369/125

(57) ABSTRACT

A data recording method of modulating the power of a laser beam in accordance with a pulse pattern, projecting the laser beam onto a write-once type optical recording medium to form a record mark and recording data in the write-once type optical recording medium, wherein the pulse pattern is constituted by a pattern in which the power of the laser beam is set to a recording power Pw within a first period and a second period and the power of the laser beam is set to an intermediate power Pm lower than the recording power Pw within a third period provided between the first period and the second period, the length of the first period and the levels of the recording power Pw and the intermediate power Pw being set to satisfy 1.7T≦tₜₒₚ2 and 1.4≦Pw/Pm where T is a length corresponding to one cycle of a reference pulse and tₜₒₚ2 is the length of the first period.

According to the thus constituted data recording method, it is possible to record data in a write-once type optical recording medium at a high linear recording velocity.

### BACKGROUND OF THE INVENTION

The present invention relates to a method and apparatus for recording data in an optical recording medium and an optical recording medium and, particularly, to a data recording method and apparatus suitable for recording data in a write-once type optical recording medium at a high linear recording velocity and a write-once type optical recording medium in which data can be recorded at a high linear recording velocity.

### DESCRIPTION OF THE PRIOR ART

Optical recording media such as the CD, DVD and the like have been widely used as recording media for recording digital data. These optical recording media can be roughly classified into optical recording media such as the CD-ROM and the DVD-ROM that do not enable writing and rewriting of data (ROM type optical recording media), optical recording media such as the CD-R and DVD-R that enable writing but not rewriting of data (write-once type optical recording media), and optical recording media such as the CD-RW and DVD-RW that enable rewriting of data (data rewritable type optical recording media).

As well known in the art, data are generally recorded in a ROM type optical recording medium using prepits formed in a substrate in the manufacturing process thereof, while in a data rewritable type optical recording medium a phase change material is generally used as the material of the recording layer and data are recorded utilizing changes in an optical characteristic caused by phase change of the phase change material.

On the other hand, in a write-once type optical recording medium, an organic dye such as a cyanine dye, phthalocyanine dye or azo dye is generally used as the material of the recording layer and data are recorded utilizing changes in an optical characteristic caused by irreversible chemical change of the organic dye or irreversible chemical change of the organic dye and physical deformation of the recording layer.

When the organic dye is to be irreversibly chemically changed or the organic dye is to be irreversibly chemically changed and the recording layer is to be physically deformed, thereby forming a record mark in the recording layer, it is normal to project a laser beam having predetermined power onto a region of the recording layer in which a record mark is to be formed.

More specifically, a region of the recording layer where a record mark is to be formed is irradiated with a laser beam whose power is set to a sufficiently high recording power Pw and, on the other hand, a region of the recording layer where no record mark is to be formed is irradiated with a laser beam whose power is set to a sufficiently low base power Pb. As a result, the organic dye is decomposed and degraded in the region of the recording layer irradiated with the laser beam whose power is set to the recording power Pw, thereby forming a record mark and, to the contrary, the organic dye is neither decomposed nor degraded in the region of the recording layer irradiated with the laser beam whose power is set to the base power Pb, thereby forming a so-called blank region.

Therefore, if the laser beam whose power is being modulated is projected onto the recording layer along grooves spirally formed on an optical recording medium while the optical recording medium is being rotated, desired data can be recorded in the recording layer of the optical recording medium.

However, in the case where the power of a laser beam is modulated to the recording power Pw for projection onto a region of the recording layer where a record mark is to be formed, thereby forming the record mark, if the linear recording velocity becomes high, the shape of a long record mark becomes improper and good signal characteristics cannot be obtained.

Although this problem can be solved to some extent by modulating the power of the laser beam using a multi-pulse train, the shape of short record marks often becomes distorted when the linear recording velocity becomes extremely high, even if the power of the laser beam is modulated using a multi-pulse train.

This problem is particularly serious in a write-once type optical recording medium having a recording layer containing an organic dye but the same problem also occurs in other write-once type optical recording media such as a write-once type optical recording medium having a recording layer including a plurality of inorganic recording films.

### SUMMARY OF THE INVENTION

It is therefore an object of the present invention to provide a data recording method suitable for recording data in a write-once type optical recording medium at a high linear recording velocity.

It is another object of the present invention to provide a data recording apparatus suitable for recording data in a write-once type optical recording medium at a high linear recording velocity.

It is a further object of the present invention to provide a write-once type optical recording medium in which data can be recorded at a high linear recording velocity

The above and other objects can be accomplished by a data recording method of modulating the power of a laser beam in accordance with a pulse pattern, projecting the laser beam onto a write-once type optical recording medium to form a record mark and recording data in the write-once type optical recording medium, wherein the pulse pattern is constituted by a pattern in which the power of the laser beam is set to a recording power Pw within a first period and a second period and the power of the laser beam is set to an intermediate power Pm lower than the recording power Pw within a third period provided between the first period and the second period, the length of the first period and the levels of the recording power Pw and the intermediate power Pm being set to satisfy 1.7T≦tₜₒₚ2 and 1.4≦Pw/Pm where T is a length corresponding to one cycle of a reference pulse and tₜₒₚ2 is the length of the first period.

According to this aspect of the present invention, even in the case where data are recorded in a write-once type optical recording medium at a high linear recording velocity, it is possible to lower the error rate and jitter and ensure a wide power margin.

In a preferred aspect of the present invention, the length of the first period is set to satisfy 1.7T≦tₜₒₚ2≦2.0T and the recording power Pw and the intermediate power Pm are set to satisfy 1.4≦Pw/Pm≦1.62.

According to this preferred aspect of the present invention, even in the case where data are recorded at a high linear recording velocity, it is possible to lower the error rate and jitter and ensure a wide power margin, while ensuring sufficiently high modulation.

In a further preferred aspect of the present invention, the linear recording velocity is set equal to or higher than 14 m/sec during recording of data in the write-once type optical recording medium.

Using an ordinary pulse pattern, it is difficult to record data in a write-once type optical recording medium at a linear recording velocity equal to or higher than 14 m/sec, which corresponds to the 4× speed of the DVD-R. However, according to the present invention, even in the case where data are recorded in a write-once type optical recording medium at a linear recording velocity equal to or higher than 14 m/sec, excellent signal characteristics can be obtained.

In a further preferred aspect of the present invention, record marks including 5T marks are formed in the write-once type optical recording medium during recording of data therein.

This is because in the case where data are recorded in a write-once type optical recording medium at a high linear recording velocity, heat for forming a record mark whose length is equal to or longer than a 5T mark affects neighboring record marks, particularly short record marks, and may deform the short record marks.

The above and other objects of the present invention can be also accomplished by a data recording apparatus for modulating the power of a laser beam in accordance with a pulse pattern, projecting the laser beam onto a write-once type optical recording medium to form a record mark and recording data in the write-once type optical recording medium, wherein the pulse pattern is constituted by a pattern in which the power of the laser beam is set to a recording power Pw within a first period and a second period and the power of the laser beam is set to an intermediate power Pm lower than the recording power Pw within a third period provided between the first period and the second period, the length of the first period and the levels of the recording power Pw and the intermediate power Pm being set to satisfy 1.7T≦tₜₒₚ2 and 1.4≦Pw/Pm where T is a length corresponding to one cycle of a reference pulse and tₜₒₚ2 is the length of the first period.

According to this aspect of the present invention, even in the case where data are recorded in a write-once type optical recording medium at a high linear recording velocity, it is possible to lower the error rate and jitter and ensure a wide power margin.

The above and other objects of the present invention can be also accomplished by a write-once type optical recording medium in which data can be recorded by modulating the power of a laser beam in accordance with a pulse pattern and projecting the laser beam thereonto, the write-once type optical recording medium being recorded with data for setting recording conditions necessary for setting the pulse pattern to a pattern in which the power of the laser beam is set to a recording power Pw within a first period and a second period and the power of the laser beam is set to an intermediate power Pm lower than the recording power Pw within a third period provided between the first period and the second period, the length of the first period and the levels of the recording power Pw and the intermediate power Pm being set to satisfy 1.7T≦tₜₒₚ2 and 1.4≦Pw/Pm where T is a length corresponding to one cycle of a reference pulse and tₜₒₚ2 is the length of the first period.

According to this aspect of the present invention, even in the case where data are recorded in a write-once type optical recording medium at a high linear recording velocity, it is possible to lower the error rate and jitter and ensure a wide power margin.

In a preferred aspect of the present invention, the write-once type optical recording medium includes a light transmittable substrate, a dummy substrate and a recording layer provided between the light transmittable substrate and the dummy substrate and containing an organic dye.

Using an ordinary pulse pattern, it is difficult to record to record data in a DVD-R type optical recording medium having such a configuration at a high linear recording velocity. However, according to the present invention, even in the case where data are recorded in a DVD-R type optical recording medium having such a configuration at a high linear recording velocity, excellent signal characteristics can be obtained.

The above and other objects and features of the present invention will become apparent from the following description made with reference to the accompanying drawings.

### BRIEF DESCRIPTION OF THE DRAWINGS

FIG. 1 is a schematic perspective view showing an optical recording medium that is a preferred embodiment of the present invention.

FIG. 2 is a schematic enlarged cross-sectional view showing the portion indicated by A in FIG. 1.

FIG. 3 is a diagram showing the waveform of a pulse pattern for modulating the power of a laser beam in the case of forming a 3T mark or a 4T mark in a recording layer of an optical recording medium.

FIG. 4 is a diagram showing the waveform of a pulse pattern for modulating the power of a laser beam in the case of forming a 5T mark to an 11T mark or a 14 T mark in a recording layer of an optical recording medium.

FIG. 5 is a diagram showing a data recording apparatus for recording data in an optical recording medium.

FIG. 6 is a graph showing the relationship between the recording power Pw of a laser beam and the number of errors measured in working example 1.

FIG. 7 is a graph showing the relationship between the recording power Pw of a laser beam and jitter measured in working example 1.

FIG. 8 is a graph showing the relationship between the recording power Pw of a laser beam and modulation measured in working example 1.

### DESCRIPTION OF THE PREFERRED EMBODIMENTS

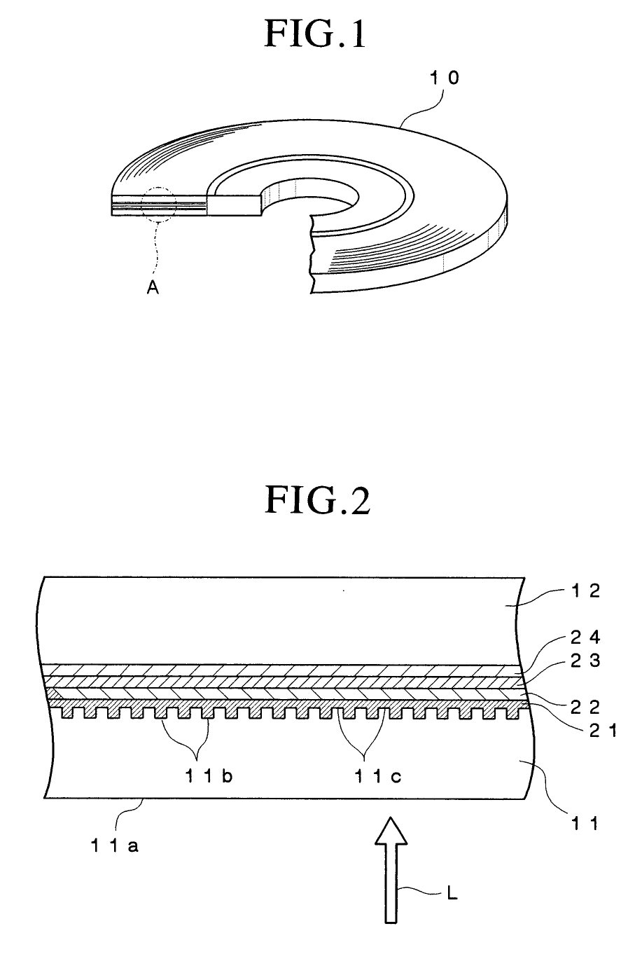

FIG. 1 is a schematic perspective view showing an optical recording medium that is a preferred embodiment of the present invention and FIG. 2 is a schematic enlarged cross-sectional view showing the portion indicated by A in FIG. 1.

An optical recording medium 10 according to this embodiment is constituted as a DVD-R type write-once optical recording medium and has an outer diameter of about 120 mm and a thickness of about 1.2 mm.

As shown in FIG. 2, the optical recording medium 10 according to this embodiment includes a light transmittable substrate 11, a dummy substrate 12, a recording layer 21, a reflective layer 22, a protective layer 23 and an adhesive layer 24.

The light transmittable substrate 11 is formed in the shape of a disk of a material having a high light transmittance with respect to a laser beam L used for recording and reproducing data.

In FIG. 2, the lower surface of the light transmittable substrate 11 constitutes a light incident plane onto which a laser beam L impinges and, as shown in FIG. 2, a groove 11b and a land 11c are spirally formed on the upper surface of the light transmittable substrate 11 from a portion in the vicinity of the center thereof toward the outer circumference thereof for guiding the laser beam L.

The light transmittable substrate 11 serves to transmit the laser beam therethrough when data are to be recorded in the optical recording medium 10 and data are to be reproduced from the optical recording medium 10 and serves as a support for ensuring the mechanical strength required for the optical recording medium 10.

The material used to form the light transmittable substrate 11 is not particularly limited insofar as the substrate 11 can serve to transmit the laser beam L and serves as the support of the optical recording medium 10 but resin is preferably used for forming the light transmittable substrate 11 since resin can be easily shaped. Illustrative examples of resins suitable for forming the light transmittable substrate 11 include polycarbonate resin, polyolefin resin, acrylic resin, epoxy resin, polystyrene resin, polyethylene resin, polypropylene resin, silicone resin, fluoropolymers, acrylonitrile butadiene styrene resin, urethane resin and the like. Among these, polycarbonate resin and polyolefin resin are most preferably used for forming the light transmittable substrate 11 from the viewpoint of easy processing, optical characteristics and the like.

In this embodiment, the light transmittable substrate 11 has a thickness of about 0.6 mm.

The dummy substrate 12 is a disk-like substrate for ensuring the thickness required by the optical recording medium 10 and, similarly to the light transmittable substrate 11, has a thickness of about 0.6 mm. Unlike the light transmittable substrate 11, the dummy substrate 12 does not require a high light transmittance because the laser beam L is not transmitted through the dummy substrate 12 when data are to be recorded in the optical recording medium 10 and data are to be reproduced from the optical recording medium 10. Therefore, the material for forming the dummy substrate 12 is not particularly limited but it is preferable to form the dummy substrate 12 of polycarbonate resin or polyolefin resin from the viewpoint of easy processing and the like.

As shown in FIG. 2, the recording layer 21 is formed so as to cover the groove 11b and the land 11c formed on the upper surface of the light transmittable substrate 11 and contains an organic dye such as a cyanine dye, merocyanine dye, methine dye or derivatives thereof, a benzenethiol metal complex, a phthalocyanine dye, a naphthalocyanine dye, an azo dye or the like.

When a laser beam L is projected onto the recording layer 21, an organic dye contained in a region of the recording layer 21 is decomposed and degraded and the optical constant of the region of the recording layer 21 irradiated with the laser beam L changes. A record mark is formed by the region of the recording layer 21 in which the organic dye is decomposed and degraded. The length of the record mark and the length of the blank region between the record mark and the neighboring record mark constitute data recorded in the recording layer 21. The record mark and the blank region are formed so as to have a length equal to an integral multiple of T, where T is a length corresponding to one cycle of a reference clock. In the case where 8/16 modulation code is employed in the DVD-R, record marks and blank regions having a length of 3T to 11T and 14T are formed.

The reflective layer 22 serves to reflect the laser beam L projected onto the recording layer 21 via the light transmittable substrate 11 when data recorded in the optical recording medium 10 are to be reproduced so as to emit it from the light transmittable substrate 11.

The material used to form the reflective layer 22 is not particularly limited insofar as it can reflect a laser beam, and the reflective layer 22 can be formed of Mg, Al, Ti, Cr, Fe, Co, Ni, Cu, Zn, Ge, Ag, Pt, Au or the like. Among these materials, it is preferable to form the reflective layer 22 of a metal material having a high reflection characteristic, such as Al, Au, Ag, Cu or alloy containing at least one of these metals, such as alloy of Al and Ti.

The protective layer 23 serves to physically and chemically protect the recording layer 21 and the reflective layer 22 formed on the light transmittable substrate 11 and is formed so as to cover the surface of the reflective layer 22.

The material used to form the protective layer 23 is not particularly limited insofar as it can physically and chemically protect the recording layer 21 and the reflective layer 22 and the protective layer 23 can be formed by curing acrylic ultraviolet curable resin or epoxy ultraviolet curable resin, for example.

The adhesive layer 24 serves to adhere a laminate including the light transmittable substrate 11, the recording layer 21, the reflective layer 22 and the protective layer 23 and the dummy substrate 12 and is preferably formed of ultraviolet ray curable adhesive agent.

The optical recording medium 10 having the above-described configuration can, for example, be fabricated in the following manner.

The light transmittable substrate 11 having the groove 11b and the land 11c on the surface thereof is first fabricated by injection molding.

Similarly, the dummy substrate 12 is fabricated by injection molding. No groove and land are formed on the dummy substrate 12.

The recording layer 21 is further formed on the surface of the light transmittable substrate 11.

The recording layer 21 can be formed, for example, by coating the light transmittable substrate 11 with a solution containing an organic dye using a spin coating process and evaporating a solvent.

The reflective layer 22 is then formed on the recording layer 21.

The reflective layer 22 can be formed by a vapor phase growth process using chemical species containing elements for forming the reflective layer 22. Illustrative examples of the vapor phase growth processes include vacuum deposition process, sputtering process and the like.

The protective layer 23 is further formed on the reflective layer 22.

The protective layer 23 can be formed, for example, by applying an acrylic ultraviolet ray curable resin or epoxy ultraviolet ray curable resin adjusted to an appropriate viscosity onto the surface of the reflective layer 22 by a spin coating process to form a coating layer and irradiating the coating layer with ultraviolet rays to cure the coating layer.

The adhesive layer 24 is then formed on the protective layer 23.

The adhesive layer 24 can be formed, for example, by applying an acrylic ultraviolet ray curable resin or epoxy ultraviolet ray curable resin adjusted to an appropriate viscosity onto the surface of the protective layer 23 by a spin coating process.

Finally, the light transmittable substrate 11 on which the recording layer 21, the reflective layer 22, the protective layer 23 and the adhesive layer 24 are laminated and the dummy substrate 12 are brought into a close contact with each other and an ultraviolet ray is projected onto the dummy substrate 12, for example, thereby adhering the adhesive layer 24 and the dummy substrate 12.

This completes the fabrication of the optical recording medium 10.

Data are recorded in the optical recording medium 10 of the above-described configuration in the following manner, for example.

When data are to be recorded in the optical recording medium 10, a laser beam L whose power is being modulated between a recording power Pw and a base power Pb is projected onto the recording layer 21 along the groove and/or land from the side of the light incidence plane 11a.

As a result, an organic dye contained in a region of the recording layer 21 irradiated with the laser beam L whose power is set to the recording power Pw is decomposed and degraded, whereby a record mark is formed. In this case, the region of the light transmittable substrate 11 corresponding to the region of the recording layer 21 may be physically deformed.

On the other hand, an organic dye is neither decomposed nor degraded in a region of the recording layer 21 irradiated with the laser beam L whose power is set to the base power Pb, whereby a blank region is formed.

However, in the case where the power of a laser beam is modulated to a recording power Pw for projection onto a region of a recording layer where a record mark is to be formed, thereby forming the record mark, if data are recorded at a high linear recording velocity, particularly, at 14 m/sec corresponding to the 4× velocity of a DVD-R, the shape of a long record mark becomes improper and good signal characteristics cannot be obtained.

Further, even in the case of modulating the power of the laser beam using a multi-pulse train, if the linear recording velocity becomes extremely high, the shape of short record marks often becomes distorted.

Therefore, in this embodiment, the laser beam L is modulated using the following pulse pattern during recording of data in the optical recording medium 10.

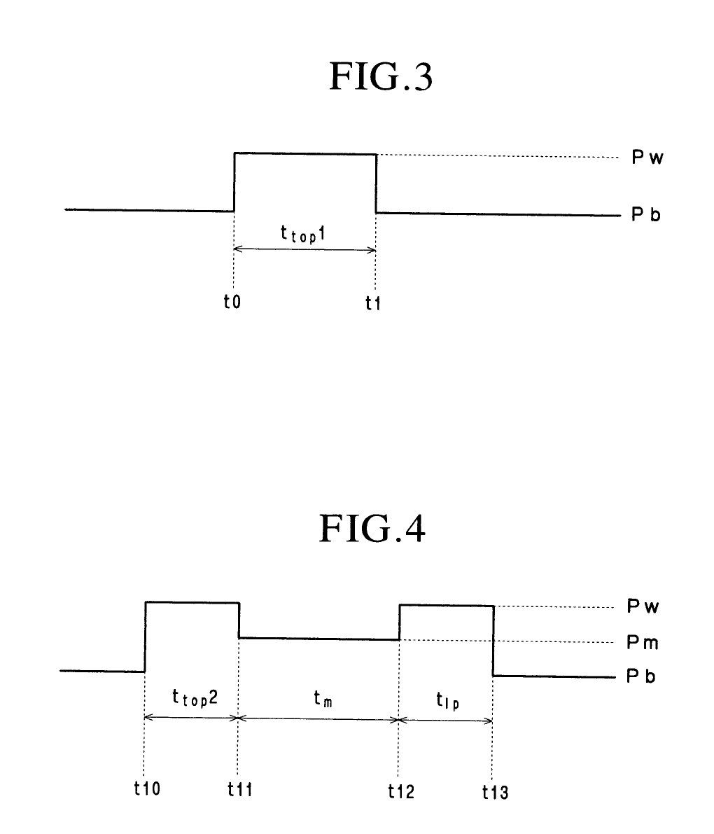

FIG. 3 is a diagram showing the waveform of a pulse pattern for modulating the power of the laser beam L in the case of forming a 3T mark or a 4T mark in the recording layer 21 of the optical recording medium 10.

As shown in FIG. 3, in the case of forming a 3T mark or a 4T mark in the recording layer 21 of the optical recording medium 10, the power of the laser beam L is modulated in accordance with a pulse pattern defined so that the level of the power of the laser beam L is increased from the base power Pb to the recording power Pw at the time t0 and decreased from the recording power Pw to the base power Pb at the time t1.

The time period tₜₒₚ1 from the time t0 to the time t1 is preferably set to be from 1.9T to 2.2T when a 3T mark is to be formed in the recording layer 21 and the time period tₜₒₚ1 is preferably set to be from 2.2T to 2.7T when a 4T mark is to be formed.

FIG. 4 is a diagram showing the waveform of a pulse pattern for modulating the power of a laser beam L in the case of forming a 5T mark to an 11T mark or a 14T mark in the recording layer 21 of the optical recording medium 10.

As shown in FIG. 4, in the case of forming a 5T mark to an 11T mark or a 14T mark in the recording layer 21 of the optical recording medium 10, the power of the laser beam L is modulated in accordance with a pulse pattern defined so that the level of the power of the laser beam L is increased from the base power Pb to the recording power Pw at the time t10, decreased from the recording power Pw to an intermediate power Pm at the time t11, increased from the intermediate power Pm to the recording power Pw at the time t12, and decreased from the recording power Pw to the base power Pb at the time t13.

In any of the cases of forming a 5T mark to an 11T mark or a 14T mark, the time period tₗₚ from the time t12 to the time t13 is preferably set to be from 0.9T to 1.1T and the time period tₘ from the time t11 to the time t12 is preferably set to be equal to or larger than (n−3.5) and equal to or smaller than (n−4.0), where n is a multiple of T, namely, 5 to 11 or 14. How the time period tₜₒₚ2 is set will be explained later.

The time period tₜₜₒₚ2 and the relationship between the recording power Pw and the intermediate power Pm are defined in the following manner.

The absolute values of the recording power Pw and the intermediate power Pm can be arbitrarily defined in accordance with the characteristic of the organic dye used in the recording layer 21 but the ratio Pw/Pm has to be defined in accordance with the length of the time period tₜₒₚ2.

Specifically, if the time period tₜₒₚ2 is set long, the total energy of the laser beam L supplied to the recording layer 21 for forming a record mark inevitably becomes high. Therefore, in order to prevent the total energy supplied to the recording layer 21 from becoming too large, the ratio Pw/Pm defined relative to the length of the time period tₜₒₚ2 needs to be made high, namely, the intermediate power Pm needs to be made relatively low.

If the length of the time period tₜₒₚ2 is set long and the ratio Pw/Pm is made high, the error rate and jitter become lower and the power margin, namely, the tolerance of the recording power Pw is increased.

Therefore, in this embodiment, the length of the time period tₜₒₚ2 and the ratio Pw/Pm are defined to satisfy the following formulae (1) and (2).

1.7T≦tₜₒₚ2 (1)

1.4≦Pw/Pm (2)

On the other hand, if the length of the time period tₜₒₚ2 is set long and the ratio Pw/Pm is made high, the modulation becomes lower. Therefore, in the case where the length of the time period tₜₒₚ2 is set too long or the ratio Pw/Pm is made too high, the modulation becomes too low and data reproduction may be affected by the considerable lowering of the modulation.

Further considering these facts, it is preferable to define the length of the time period tₜₒₚ2 and the ratio Pw/Pm to satisfy the following formulae (3) and (4).

1.7T≦tₜₒₚ2≦2.0T (3)

1.4≦Pw/Pm≦1.62 (4)

In particular, when the length of the time period tₜₒₚ2 is about 1.7T, it is preferable to define the ratio Pw/Pm to satisfy the following formula (5) and when the length of the time period tₜₒₚ2 is about 1.8T, it is preferable to define the ratio Pw/Pm to satisfy the following formula (6). Further, when the length of the time period tₜₒₚ2 is about 2.0T, it is preferable to define the ratio Pw/Pm to satisfy the following formula (7).

1.4≦Pw/Pm≦1.5 (5)

1.5≦Pw/Pm≦1.55 (6)

1.57≦Pw/Pm≦1.62 (7)

If the length of the time period tₜₒₚ2 and the ratio Pw/Pm are defined in the above described manner, sufficient modulation can be obtained and a low error rate and low jitter can be achieved. Further, a wide power margin can be ensured.

In particular, if the length of the time period tₜₒₚ2 is set to be about 1.8T and the ratio Pw/Pm is defined to satisfy the above formula (6), the best balance between the modulation and the error rate and jitter can be obtained.

The above described pulse pattern s are particularly advantageous in recording data in the optical recording medium 10 shown in FIG. 1 at a linear recording velocity higher than 14 m/sec.

In this embodiment, data for setting recording conditions that a data recording apparatus needs to set data recording conditions, namely, pulse pattern s, in the above described manner when the linear data recording velocity is equal to or higher than a predetermined value are recorded in the optical recording medium 10 in the form of wobbles or pre-pits and the data recording apparatus correspondingly stores data for setting recording conditions or programs for setting recording conditions necessary for defining pulse pattern s in the above described manner based on the data for setting recording conditions recorded in the optical recording medium 10 when the linear data recording velocity is equal to or higher than a predetermined value.

In this embodiment, information designating the kind of optical recording medium is recorded in the optical recording medium 10 as data for setting recording conditions and the data recording apparatus stores programs for setting recording conditions necessary for defining pulse pattern s in the above described manner when the kind of the optical recording medium 10 is identified and is constituted so as to read the kind of the optical recording medium recorded in the optical recording medium 10, select the program for setting recording conditions corresponding to the thus read kind of the optical recording medium from among the stored programs for setting recording conditions, define pulse pattern s in the above described manner, and modulate the power of a laser beam in accordance with the thus defined pulse pattern s, thereby recording data in the optical recording medium 10.

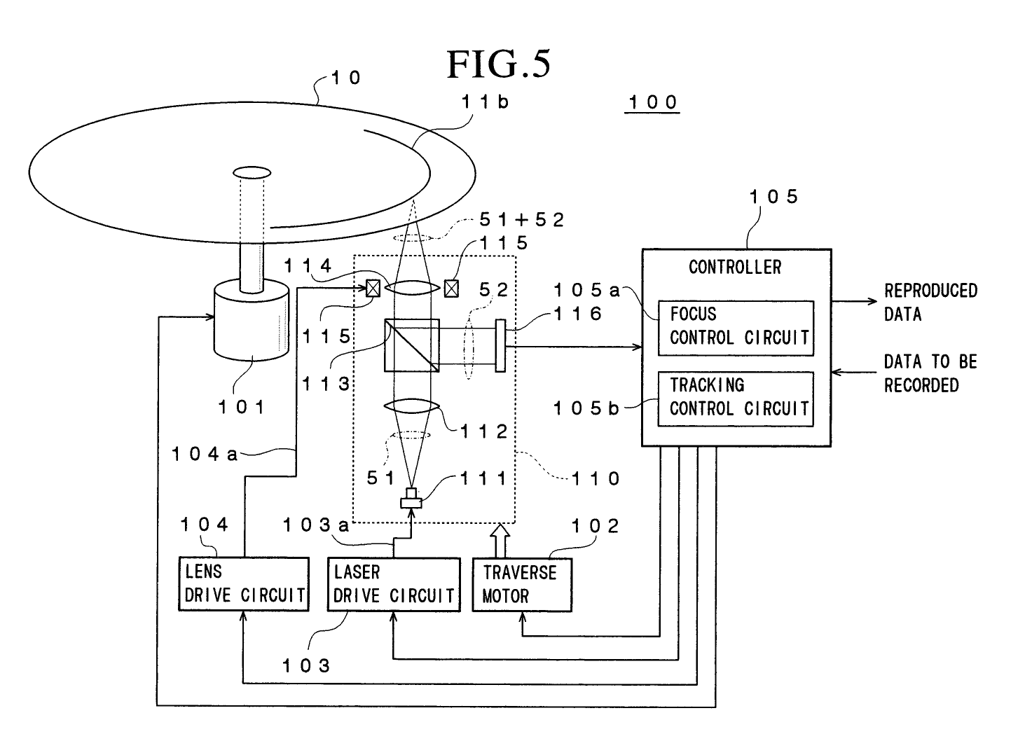

FIG. 5 is a diagram showing a data recording apparatus for recording data in the optical recording medium 10.

As shown in FIG. 5, a data recording apparatus 100 includes a spindle motor 101 for rotating the optical recording medium 10, an optical head 110 for projecting a laser beam 51 onto the optical recording medium 10 and receiving the laser beam 52 reflected by the optical recording medium 10, a traverse motor 102 for moving the optical head 110 in a radial direction of the optical recording medium 10, a laser drive circuit 103 for feeding a laser drive signal 103a to the optical head 110, a lens drive circuit 104 for feeding a lens drive signal 104a to the optical head 110, and a controller 105 for controlling the spindle motor 101, the traverse motor 102, the laser drive circuit 103 and the lens drive circuit 104.

The optical head 110 includes a laser beam source 111 for emitting the laser beam 51 based on the laser drive signal 103a, a collimator lens 112 for making the laser beam 51 emitted from the laser beam source 111 a parallel beam, a beam splitter 113 disposed in the optical path of the laser beam 51, an objective lens 105 for condensing the laser beam 51, an actuator 106 for moving the objective lens 105 in the vertical direction and the horizontal direction based on the lens drive signal 104a, and a photodetector 116 for receiving the laser beam 52 reflected by the optical recording medium 10 and photoelectrically converting it.

The spindle motor 101 is controlled by the controller 105 so as to rotate the optical recording medium 10 at a desired speed of rotation.

The methods for controlling the rotation of the optical recording medium 10 are roughly classified into the CLV method of rotating the optical recording medium 10 while keeping the linear velocity constant and the CAV method of rotating the optical recording medium 10 while keeping the angular velocity constant.

In the case where the rotation of the optical recording medium 10 is controlled using the CLV method, since the data transfer rate can be kept constant irrespective of the position in the radial direction of the optical recording medium 10 where data are being recorded or data are being reproduced, data can be recorded in or data can be reproduced from the optical recording medium 10 at a high transfer rate at all times, so that data can be recorded at high density. On the other hand, however, since the speed of rotation of the optical recording medium 10 has to be changed in accordance with the position in the radial direction of the optical recording medium 10 where data are being recorded or data are being reproduced, it is necessary to control the spindle motor 101 in a complicated manner and, therefore, the random access speed is low.

To the contrary, in the case where the rotation of the optical recording medium 10 is controlled using the CAV method, since the spindle motor 101 can be controlled in a simple manner, the random access speed is high. On the other hand, however, the CAV method is disadvantageous in that the data recording density at the outer circumference portion of the optical recording medium 10 becomes slightly lower.

The traverse motor 102 is controlled by the controller 105 so as to move the optical head 110 in the radial direction of the optical recording medium 10 and when data are to be recorded in the optical recording medium 10 or data are to be reproduced from the optical recording medium 10, it moves the optical head 110 so that the spot of the laser beam 51 gradually moves along the groove 11b spirally formed on the optical recording medium 10 from the inner circumference portion to the outer circumference portion of the optical recording medium 10.

In the case of changing the position in the radial direction of the optical recording medium 10 where data are to be recorded or data are to be reproduced, the controller 105 controls the traverse motor 102 to move the spot of the laser beam 51 to the desired position on the optical recording medium 10.

The laser drive circuit 103 is controlled by the controller 105 so as to feed a laser drive signal 103a to the laser beam source 111 of the optical head 110. The laser beam source 111 generates a laser beam 51 whose power corresponds to the laser drive signal 103a fed from the laser drive circuit 103.

When data are to be recorded in the optical recording medium 10, the laser drive circuit 103 generates a laser drive signal 103a whose intensity is modulated so that the power of the laser beam 51 can be modulated in accordance with the above described pulse pattern and feeds it to the laser beam source 111 of the optical head 110. On the other hand, when data are to be reproduced from the optical recording medium 10, the laser drive circuit 103 generates a laser drive signal having a constant intensity and feeds it to the laser beam source 111 of the optical head 110, thereby causing the laser beam source 111 to emit a laser beam 51 having a reproduction power Prof a constant level.

The lens drive circuit 104 is controlled by the controller 105 so as to feed a lens drive signal to the actuator 115.

The controller 105 is provided with a focus control circuit 105a and when the focus control circuit 105a is turned on, the spot of the laser beam 51 is focused on the recording layer 21 of the optical recording medium 10 and fixed thereon. The controller is further provided with a tracking control circuit 105b and when the tracking control circuit 105b is turned on, the spot of the laser beam 51 automatically follows the groove 11b of the optical recording medium 10. Therefore, it is possible for the spot of the laser beam 51 to be correctly focused on the recording layer 21 of the optical recording medium 10 and to follow the groove 11b of the optical recording medium 10.

In this embodiment, the controller 105 of the data recording apparatus 100 further includes a memory (not shown) and programs for setting recording conditions are stored in the memory.

The thus constituted data recording apparatus 100 records data in the optical recording medium 10 in the following manner.

When data are to be recorded in the optical recording medium 10, the controller 105 reads the kind of the optical recording medium 10 recorded in the optical recording medium 10 as the data for setting recording conditions, reads the program for setting recording conditions corresponding to the thus read kind of the optical recording medium 10 from among the programs for setting recording conditions stored in the memory, defines data recording conditions, namely, pulse patterns, in accordance with the thus read program for setting recording conditions when the linear data recording velocity is equal to or higher than a predetermined value, causes the laser drive circuit 103 to output a laser drive signal 103a whose intensity is modulated in accordance with the thus defined pulse pattern s to the laser beam source 111, and modulates the power of the laser beam 51 emitted from the laser beam source 111, thereby recording data in the optical recording medium 10.

To the contrary, when data recorded in the optical recording medium 10 are to be reproduced, the controller 105 causes the laser drive circuit 103 to output a laser drive signal 103a having a predetermined intensity to the laser beam source 111, thereby causing the laser beam source 111 to emit a laser beam 51 having a reproduction power Pr of a predetermined level.

The laser beam 51 emitted from the laser beam source 111 is projected onto the recording layer 21 of the optical recording medium 10 and reflected by the recording layer 21 of the optical recording medium 10.

The laser beam 52 reflected by the recording layer 21 of the optical recording medium 10 is made a parallel beam by the objective lens 114 and reflected by the beam splitter 113.

The laser beam 52 reflected by the beam splitter 113 impinges on the photodetector 116 to be photoelectrically detected thereby and the thus produced data are output to the controller 105.

According to the above described embodiment, even in the case where data are recorded at a high linear recording velocity, particularly, at 14 m/sec corresponding to the 4× velocity of a DVD-R, it is possible to ensure sufficient modulation and reduce the error rate and jitter.

### WORKING EXAMPLE

Hereinafter, a working example will be set out in order to further clarify the advantages of the present invention.

### Working Example 1

An optical recording medium sample #1 was fabricated in the following manner.

A light transmittable substrate made of polycarbonate and having a thickness of 0.6 mm was first fabricated by an injection molding process so that a groove having a width of 300 nm and a depth of 170 nm was formed in the surface thereof in such a manner that the pitch of the groove was 740 nm.

The spin coating method was used to apply a solution containing an azo nickel complex dye onto the surface of the light transmittable substrate on which the groove was formed, thereby forming a recording layer having a thickness of 100 nm. Next, a reflective layer consisting of an alloy containing Ag as a primary component and having a thickness of 100 nm was formed on the recording layer using a sputtering process.

Further, the spin coating method was used to coat the surface of the reflective layer with an ultraviolet curable resin whose viscosity was adjusted to form a coating layer and the coating layer was irradiated with ultraviolet rays, thereby curing the coating layer to form a protective layer having a thickness of 10 μm.

The surface of the protective layer was then coated using the spin coating method with an ultraviolet curable adhesive agent to form an adhesive layer having a thickness of 50 μm.

Further, a dummy substrate fabricated using the injection molding process and made of polycarbonate so as to have a thickness of 0.6 mm was brought into close contact with the adhesive layer and an ultraviolet ray was projected onto the adhesive layer, thereby bonding the dummy substrate and the adhesive layer. Thus, the optical recording medium sample #1 was fabricated.

Random signals including 3T to 11T and 14T marks were recorded in the recording layer of the thus fabricated optical recording medium sample #1 at a linear recording velocity of 14 m/sec using the pulse pattern s shown in FIGS. 3 and 4 and set in accordance with a recording condition #1.

Under the recording condition #1, tₜ^{top}1 was set to 2.05T when a 3T mark was formed, tₜₒₚ1 was set to 2.40T when a 4T mark was formed, tₜₒₚ2 was set to 1.50T and tₗₚ was set to 1.00T when a 5T mark to an 11T mark or a 14T mark was formed, tₘ was set to (n−3.5)T, where “n” was a multiple of T, namely, 5T to 11T or 14T, and the absolute values of the recording power Pw and the intermediate power Pm were varied so that the ratio Pw/Pm of the recording power Pw to the intermediate power Pm was kept at 1.375.

Further, an optical recording medium sample #2 was fabricated in the manner of the optical recording sample #1 and random signals including 3T to 11T and 14T marks were recorded in the recording layer of the thus fabricated optical recording medium sample #2 at a linear recording velocity of 14 m/sec using the pulse pattern s shown in FIGS. 3 and 4 and set in accordance with a recording condition #2.

Under the recording condition #2, tₜₒₚ1 was set to 2.05T when a 3T mark was formed, tₜₒₚ1 was set to 2.40T when a 4T mark was formed, tₜₒₚ2 was set to 1.70T and tₗₚ was set to 1.00T when a 5T mark to an 11T mark or a 14T mark was formed, tₘ was set to (n−3.7)T, where “n” was a multiple of T, namely, 5T to 11T or 14T, and the absolute values of the recording power Pw and the intermediate power Pm were varied so that the ratio Pw/Pm of the recording power Pw to the intermediate power Pm was kept at 1.430.

Furthermore, an optical recording medium sample #3 was fabricated in the manner of the optical recording sample #1 and random signals including 3T to 11T and 14T marks were recorded in the recording layer of the thus fabricated optical recording medium sample #3 at a linear recording velocity of 14 m/sec using the pulse pattern s shown in FIGS. 3 and 4 and set in accordance with a recording condition #3.

Under the recording condition #3, tₜₒₚ1 was set to 2.05T when a 3T mark was formed, tₜₒₚ1 was set to 2.40T when a 4T mark was formed, tₜₒₚ2 was set to 1.80T and tₗₚ was set to 1.00T when a 5T mark to an 11T mark or a 14T mark was formed, tₘ was set to (n−3.8)T, where “n” was a multiple of T, namely, 5T to 11T or 14T, and the absolute values of the recording power Pw and the intermediate power Pm were varied so that the ratio Pw/Pm of the recording power Pw to the intermediate power Pm was kept at 1.525.

Moreover, an optical recording medium sample #4 was fabricated in the manner of the optical recording sample #1 and random signals including 3T to 11T and 14T marks were recorded in the recording layer of the thus fabricated optical recording medium sample #4 at a linear recording velocity of 14 m/sec using the pulse pattern s shown in FIGS. 3 and 4 and set in accordance with a recording condition #4.

Under the recording condition #4, tₜₒₚ1 was set to 2.05T when a 3T mark was formed, tₜₒₚ1 was set to 2.40T when a 4T mark was formed, tₜₒₚ2 was set to 2.00T and tₗₚ was set to 1.00T when a 5T mark to an 11T mark or a 14T mark was formed, tₘ was set to (n−4.0)T where “n” was a multiple of T, namely, 5T to 11T or 14T, and the absolute values of the recording power Pw and the intermediate power Pm were varied so that the ratio Pw/Pm of the recording power Pw to the intermediate power Pm was kept at 1.595.

The recording condition #1 did not satisfy the above described formulae (1) and (2) but each of the recording conditions #2 to #4 satisfied the above described formulae (5), (6) and (7) and, therefore, satisfied the above described formulae (3) and (4) and the above described formulae (1) and (2).

Then, the number of errors of the random signals recorded in the optical medium samples #1 to #4 under the recording conditions #1 to #4 were measured.

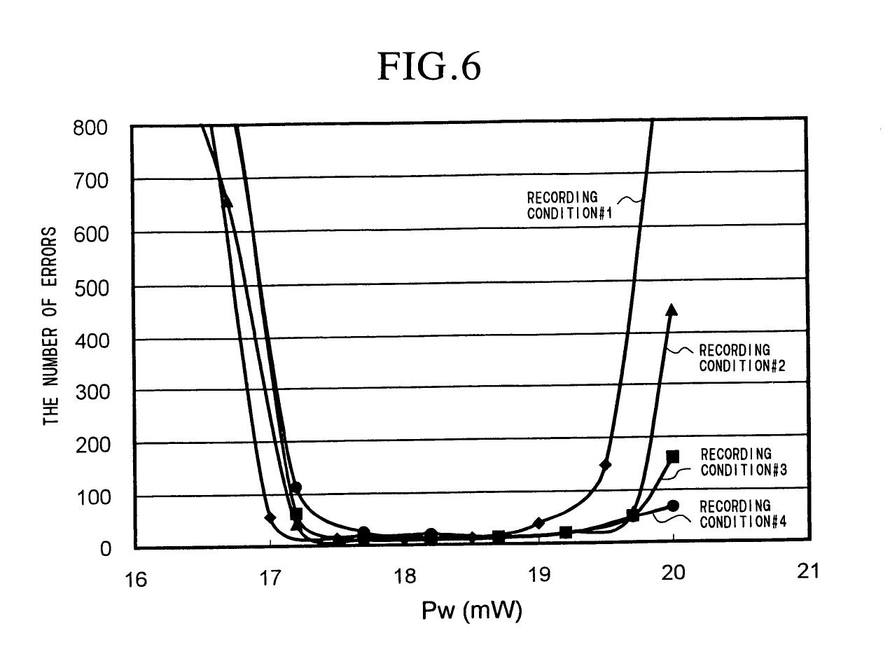

The results of measurements are shown in FIG. 6, wherein the number of errors is shown as the maximum number of errors generated during the 8ECC period where the ECC means errors correction code.

As shown in FIG. 6, it was found that the upper limit of the power margin was higher in the case where random signals were recorded using the recording conditions #2 to #4 than that in the case where they were recorded using the recording condition #1 and that the upper limit of the power margin was maximum in the case where random signals were recorded using the recording condition #4.

Further, clock jitter of random signals recorded in accordance with the recording conditions #1 to #4 was measured. The fluctuation σ of the reproduced signal was measured using a time interval analyzer and the clock jitter was calculated as σ/Tw, where Tw was one clock period.

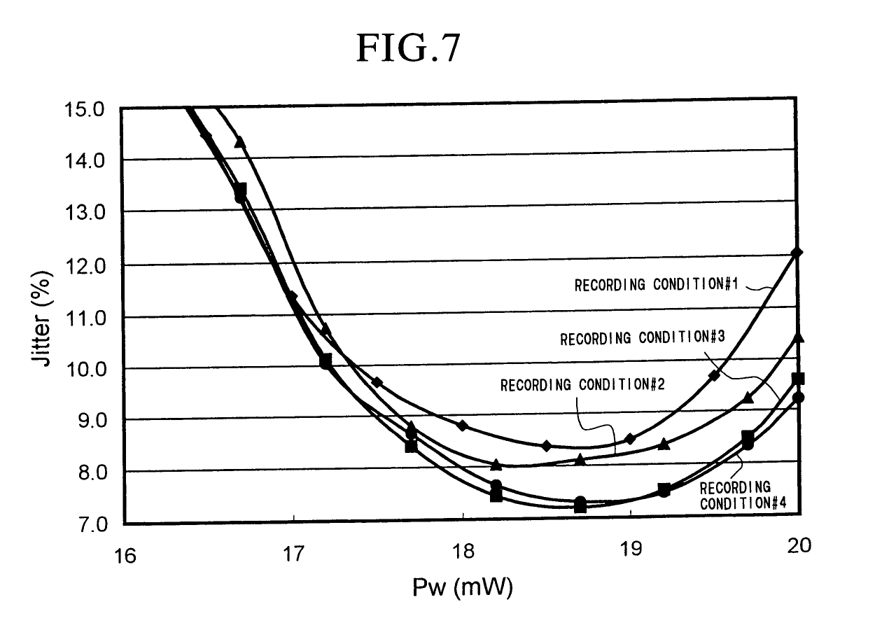

The results of measurement are shown in FIG. 7.

As shown in FIG. 7, it was found that the power margin was wider and jitter was lower in the case where random signals were recorded using the recording conditions #2 to #4 than those in the case where they were recorded using the recording condition #1 and that the power margin was widest and jitter was lowest in the case where random signals were recorded using the recording condition #4.

Further, it was found that in the case where random signals were recorded using the recording conditions #2 to #4, jitter was lowest when the recording power Pw of the laser beam was about 18.7 mW.

Then, modulation of random signals recorded in accordance with the recording conditions #1 to #4 was measured.

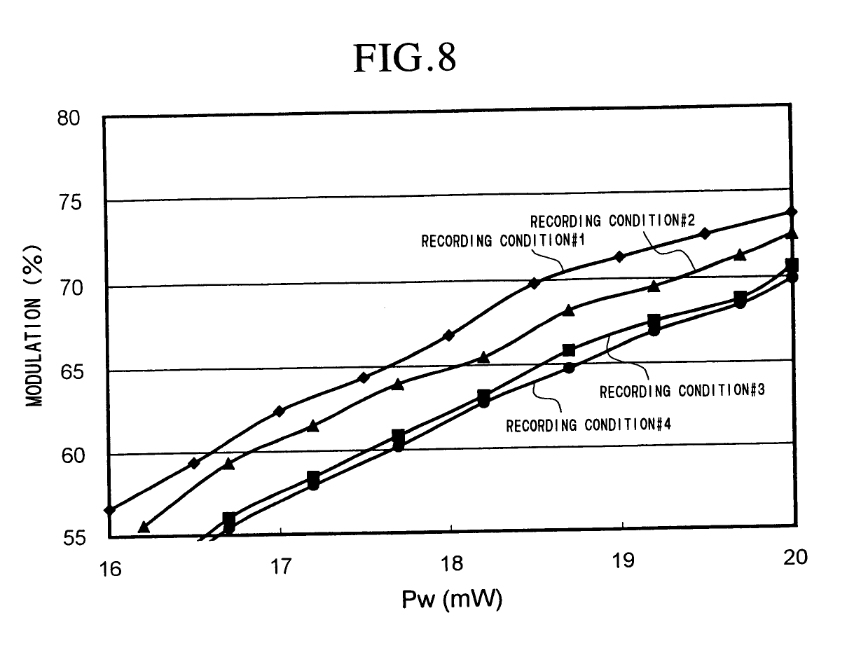

The results of measurement are shown in FIG. 8.

As shown in FIG. 8, it was found that modulation was lower in the case where they were recorded using the recording condition #1 than that in the case where random signals were recorded using the recording conditions #2 to #4.

However, it was found that when the recording power Pw of the laser beam was set to about 18.7 mW at which jitter was lowest in the case where random signals were recorded using the recording conditions #1 to #4, modulation was about 65% even using the recording condition #4 and the reduction in modulation did not affect the reproduction of data.

In view of the above, it was confirmed that if tₜₒₚ2 and the ratio Pw/Pm were set to satisfy the above mentioned formulae (1) and (2), it was possible to lower the error rate and jitter and ensure a wide power margin, while sufficiently high modulation could be ensured. In particular, when random signals were recorded under the recording condition #3 in which tₜₒₚ2 was set to be 1.89T and the ratio Pw/Pm was set to be 1.525, the best balance between the modulation and the error rate and jitter could be obtained.

The present invention has thus been shown and described with reference to specific embodiments and working examples. However, it should be noted that the present invention is in no way limited to the details of the described arrangements but changes and modifications may be made without departing from the scope of the appended claims.

For example, in the above described embodiment, information designating the kind of the optical recording medium is recorded in the optical recording medium 10 as data for setting recording conditions and the data recording apparatus 100 stores programs for setting recording conditions necessary for defining pulse pattern s in the above described manner when the kind of the optical recording medium 10 is identified and is constituted so as to read the kind of the optical recording medium recorded in the optical recording medium 10, select the program for setting recording conditions corresponding to the thus read kind of the optical recording medium from among the stored programs for setting recording conditions, define pulse pattern s in the above described manner, and modulate the power of a laser beam in accordance with the thus defined pulse pattern s, thereby recording data in the optical recording medium 10. However, it is not absolutely necessary for information designating the kind of the optical recording medium to be recorded in the optical recording medium 10 and for programs for setting recording conditions necessary for defining pulse pattern s in the above described manner to be stored in the data recording apparatus 100 and data recorded in the optical recording medium 10 and data stored in the data recording apparatus 100 are not particularly limited insofar as the data recording apparatus 100 can define pulse pattern s in the above described manner based on the data recorded in the optical recording medium 10 and the data stored in the data recording apparatus 100.

Furthermore, although the above described embodiment was explained regarding the DVD-R type optical recording medium 10 and the case of recording data in the DVD-R type optical recording medium 10, the present invention is not limited to application to the DVD-R type optical recording medium 10 and the case of recording data in the DVD-R type optical recording medium 10 but can be widely applied to write-once type optical recording media and the case of recording data in write-once type optical recording media. Illustrative examples of write-once type optical recording media include CD-R type optical recording media, next-generation type optical recording media and optical recording media having a recording layer formed with a plurality of recording films containing inorganic materials.

According to the present invention, it is possible to provide a data recording method suitable for recording data in a write-once type optical recording medium at a high linear recording velocity.

Further, according to the present invention, it is possible to provide a data recording apparatus suitable for recording data in a write-once type optical recording medium at a high linear recording velocity.

Furthermore, according to the present invention, it is possible to provide a write-once type optical recording medium in which data can be recorded at a high linear recording velocity.

1. A data recording method of modulating the power of a laser beam in accordance with a pulse pattern , projecting the laser beam onto a write-once type optical recording medium to form a record mark and recording data in the write-once type optical recording medium, wherein the pulse pattern is constituted by a pattern in which the power of the laser beam is set to a recording power Pw within a first period and a second period and the power of the laser beam is set to an intermediate power Pm lower than the recording power Pw within a third period provided between the first period and the second period, the length of the first period and the levels of the recording power Pw and the intermediate power Pw being set to satisfy 1.7T≦tₜₒₚ2 and 1.4≦Pw/Pm where T is a length corresponding to one cycle of a reference pulse and tₜₒₚ2 is the length of the first period.

2. A data recording method in according with claim 1, wherein the length of the first period is set to satisfy 1.7T≦tₜₒₚ2≦2.0T and the recording power Pw and the intermediate power Pm are set to satisfy 1.4≦Pw/Pm≦1.62.

3. A data recording method in according with claim 1, wherein the linear recording velocity is set equal to or higher than 14 m/sec during recording of data in the write-once type optical recording medium.

4. A data recording method in according with claim 2, wherein the linear recording velocity is set equal to or higher than 14 m/sec during recording of data in the write-once type optical recording medium.

5. A data recording method in according with claim 1, wherein record marks including 5T marks are formed in the write-once type optical recording medium during recording of data therein.

6. A data recording method in according with claim 2, record marks including 5T marks are formed in the write-once type optical recording medium during recording of data therein.

7. A data recording apparatus for modulating the power of a laser beam in accordance with a pulse pattern , projecting the laser beam onto a write-once type optical recording medium to form a record mark and recording data in the write-once type optical recording medium, wherein the pulse pattern is constituted by a pattern in which the power of the laser beam is set to a recording power Pw within a first period and a second period and the power of the laser beam is set to an intermediate power Pm lower than the recording power Pw within a third period provided between the first period and the second period, the length of the first period and the levels of the recording power Pw and the intermediate power Pw being set to satisfy 1.7T≦tₜₒₚ2 and 1.4≦Pw/Pm where T is a length corresponding to one cycle of a reference pulse and tₜₒₚ2 is the length of the first period.

8. A data recording apparatus in accordance with claim 7, wherein the length of the first period is set to satisfy 1.7T≦tₜₒₚ2≦2.0T and the recording power Pw and the intermediate power Pm are set to satisfy 1.4≦Pw/Pm≦1.62.

9. A write-once type optical recording medium in which data can be recorded by modulating the power of a laser beam in accordance with a pulse pattern and projecting the laser beam thereonto, the write-once type optical recording medium being recorded with data for setting recording conditions necessary for setting the pulse pattern to a pattern in which the power of the laser beam is set to a recording power Pw within a first period and a second period and the power of the laser beam is set to an intermediate power Pm lower than the recording power Pw within a third period provided between the first period and the second period, the length of the first period and the levels of the recording power Pw and the intermediate power Pw being set to satisfy 1.7T≦tₜₒₚ2 and 1.4≦Pw/Pm where T is a length corresponding to one cycle of a reference pulse and tₜₒₚ2 is the length of the first period.

10. A write-once type optical recording medium in accordance with claim 9, wherein the length of the first period and the levels of the recording power Pw and the intermediate power Pm are set to satisfy 1.7T≦tₜₒₚ2 and 1.4≦Pw/Pm.

11. A write-once type optical recording medium in accordance with claim 9 which includes a light transmittable substrate, a dummy substrate and a recording layer provided between the light transmittable substrate and the dummy substrate and containing an organic dye.

12. A write-once type optical recording medium in accordance with claim 10 which includes a light transmittable substrate, a dummy substrate and a recording layer provided between the light transmittable substrate and the dummy substrate and containing an organic dye.
